(19) United States
(12) Patent Application Publication
(10) Pub. No.: US 2007/0088489 A1
(43) Pub. Date: Apr. 19, 2007

(54) Traffic information processing device, traffic information processing program, and vehicle function control system

(75) Inventor: Masakuni Tsuge, Minato-ku (JP)

Correspondence Address: LAHIVE & COCKFIELD, LLP, ONE POST OFFICE SQUARE, BOSTON, MA, 02109-2127, US

(73) Assignee: Honda Motor Co., Ltd., Tokyo (JP)

(21) Appl. No.: 11/582,891

(22) Filed: Oct. 18, 2006

(30) Foreign Application Priority Data
Oct. 18, 2005 (JP) 2005-303125

(51) Int. Cl. G08G 1/00; G08G 1/123

(52) U.S. Cl. 701/117; 340/995.13

(57) ABSTRACT

According to a navigation device in accordance with the present invention, only when there is a difference having a predetermined magnitude between a first traffic variable measured by a first processor and a second traffic variable based on traffic information distributed from a navigation server, the first traffic variable is transmitted to the navigation server as traffic information. This prevents new traffic information from being transmitted to the navigation server from the navigation device mounted in a vehicle or a probe car when the new traffic information is not worth updating of the traffic information stored in the navigation server, thus restraining a waste of traffic information transmission cost.

### BACKGROUND OF THE INVENTION

1. Field of the Invention

The present invention relates to a device mounted in a vehicle to processes traffic information on roads through which the vehicle travels, a program that imparts a function for such processing to the device mounted in the vehicle, and a system that controls vehicle functions.

2. Description of the Related Art

Traffic information distributed to car navigation systems includes information provided by Vehicle Information and Communication System Center (hereinafter referred to as “the VICS Center”). However, roads covered by the VICS Center information are limited to main highways, such as expressways. Hence, in order to supplement the information provided by the VICS Center, there has been proposed a technique in which probe cars or floating cars are used to gather traffic information, including drive time or the like on other roads, and the gathered traffic information is subjected to information processing, such as statistical operation, as necessary, then the processed traffic information is combined with the information from the VICS Center and distributed to a car navigation system (refer to, for example, Japanese Unexamined Patent Application Publication No. H7-29098 and Japanese Unexamined Patent Application Publication No. 2004-258884).

However, even if there is no need to update traffic information stored in a server, as in a case where a traffic situation has not changed much after gathering traffic information through a probe car and storing it in the server, the probe car will newly transmit traffic information to the server, leading to a waste of communication cost.

### SUMMARY OF THE INVENTION

Accordingly, it is an object of the present invention to provide a device that permits proper control of a communication information volume, a program that imparts a function for accomplishing such control to an in-car device, and a system for controlling vehicle functions in order to save traffic information transmission cost.

To this end, according to one aspect of the present invention, there is provided a traffic information processing device including:

a first processor that measures a traffic variable based on a traffic condition of a road through which a vehicle has traveled and stores the traffic variable as a first traffic variable in a first storage;

a second processor that receives traffic information distributed from an external information processing device and stores a traffic variable based on the traffic information as a second traffic variable in a second storage;

a third processor that calculates a difference or a ratio between the first traffic variable stored in the first storage and the second traffic variable stored in the second storage in the same road unit and stores the difference or the ratio in a third storage; and

a fourth processor that determines whether the difference or the ratio stored in the third storage exceeds a threshold value, and transmits the first traffic variable as traffic information to an external information processing terminal if the difference or the ratio exceeds the threshold value.

The traffic information processing device in accordance with the present invention transmits the first traffic variable as traffic information to the external information processing device if the difference between the measured first traffic variable and the second traffic variable based on the traffic information distributed from the external information processing device has a certain magnitude. This arrangement prevents new traffic information from being transmitted to the external information processing device from a traffic information processing device mounted in a vehicle (probe car) if there is hardly a need for updating traffic information stored in the external information processing device, thus restraining a waste of traffic information transmission cost. In other words, the traffic information processing device in accordance with the present invention controls the volume of traffic information transmitted to an external information processing terminal to save traffic information transmission cost.

Alternatively, the third processor calculates a difference or a ratio of required travel time of a vehicle as the difference or the ratio between the first and the second traffic variables in the same road unit.

With this arrangement, a difference between traffic information on a road through which a vehicle travels and traffic information stored in the external information processing terminal is determined on the basis of a difference or a ratio of time required for the vehicle to travel on the same road information.

Alternatively, the third processor calculates a difference or a ratio of a vehicular traffic volume as a difference or a ratio between the first and the second traffic variables in the same road unit.

With this arrangement, a difference between traffic information on a road through which a vehicle travels and traffic information stored in the external information processing terminal is determined on the basis of a difference or a ratio in vehicle traffic volume on the same road information.

According to another aspect of the present invention, there is provided a traffic information processing program for imparting functions which comprises:

a first processing function for measuring a traffic variable based on a traffic condition of a road through which a vehicle has traveled and storing the traffic variable as a first traffic variable in a first storage;

a second processing function for receiving traffic information distributed from an external information processing device and storing a traffic variable based on the traffic information as a second traffic variable in a second storage;

a third processing function for calculating a difference or a ratio between the first traffic variable stored in the first storage and the second traffic variable stored in the second storage in the same road unit and storing the difference or the ratio in a third storage; and

a fourth processing function for determining whether the difference or the ratio stored in the third storage exceeds a threshold value, and transmitting the first traffic variable as traffic information to an external information processing terminal if the difference or the ratio exceeds the threshold value.

According to the traffic information processing program in accordance with the present invention, a function for controlling the volume of traffic information to be transmitted to an external information processing terminal is imparted to a device mounted in a vehicle in order to save traffic information transmission cost.

According to still another aspect of the present invention, there is provided a vehicle function control system that distributes or broadcasts a part or all of the aforesaid traffic information processing program to the aforesaid device mounted in a vehicle so as to construct the aforesaid traffic information processing device.

The vehicle function control system in accordance with the present invention makes it possible to construct a traffic information processing device capable of controlling the volume of traffic information to be transmitted to an external information processing terminal by downloading a part or all of the program into the in-car device at an arbitrary timing, thus saving traffic information transmission cost.

### BRIEF DESCRIPTION OF THE DRAWINGS

FIG. 1 is a diagram illustrating the configuration of a traffic information processing device in accordance with the present invention;

FIG. 2 is a diagram for explaining functions of the traffic information processing device in accordance with the present invention; and

FIG. 3 is a diagram illustrating search routes.

### DESCRIPTION OF THE PREFERRED EMBODIMENTS

Embodiments of a traffic information processing device, a traffic information processing program, and a vehicle function control system in accordance with the present invention will be explained in conjunction with the accompanying drawings.

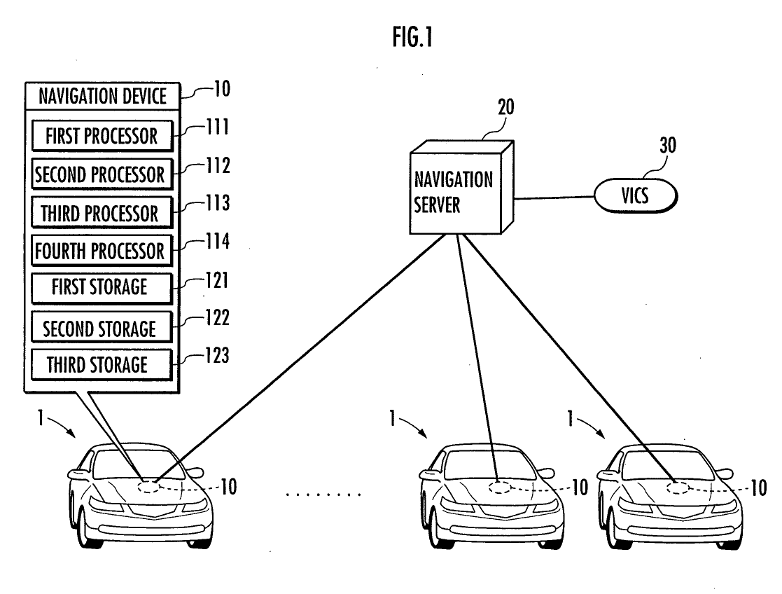

FIG. 1 shows navigation devices 10 corresponding to the traffic information processing devices in the present invention (hereinafter referred to as “the navi-devices”) individually mounted in a plurality of vehicles 1. Each of the navigation devices 10 has a function for information communication, via a network, with a navigation server 20 corresponding to the external information processing device in the present invention (hereinafter referred to as “the navi-server”). The communication function may be added to the navi-devices 10 by connecting communication equipment, such as cellular telephones or the like, to the navi-devices 10. The navi-server 20 acquires VICS information from a VICS (information processing device) 30 via a network and stores it in a storage.

The navi-device 10 includes a panel for image display (and control), control buttons, a first processor 111, a second processor 112, a third processor 113, a fourth processor 114, a first storage 121, a second storage 122, and a third storage 123. The navi-device 10 further includes a computer (microcomputer) having central processing units (CPU) constituting the processors, memories, such as ROMs and RAMs, constituting the storages, and hardware resources for inputs/outputs and the like. The computer is provided with various functions by means of the traffic information control program in accordance with the present invention, which is a piece of software stored in a storage or a memory. The traffic information control program may be stored beforehand in a memory, such as a ROM, of an in-car computer, or a part or all of the program may be downloaded to the in-car computer via a network from a vehicle function control system (not shown) constituted of a server or a satellite at an arbitrary timing, e.g., upon a request from the in-car computer, and the downloaded program may be stored in the memory.

The first processor 111 measures a traffic variable based on a traffic condition of a road through which a vehicle 1 has passed and stores the traffic variable in the first storage 121 as a first traffic variable.

The second processor 112 receives traffic information distributed from the navi-server 20 and stores a traffic variable based on the traffic information in the second storage 122 as a second traffic variable.

The third processor 113 calculates, on the same road unit, the difference between the first traffic variable stored in the first storage 121 and the second traffic variable stored in the second storage 122, and stores the difference in the third storage 123.

The fourth processor 114 determines whether the difference stored in the third storage 123 exceeds a threshold value. If the difference exceeds the threshold value, then the fourth processor 114 transmits the first traffic variable to the navi-server 20 as traffic information.

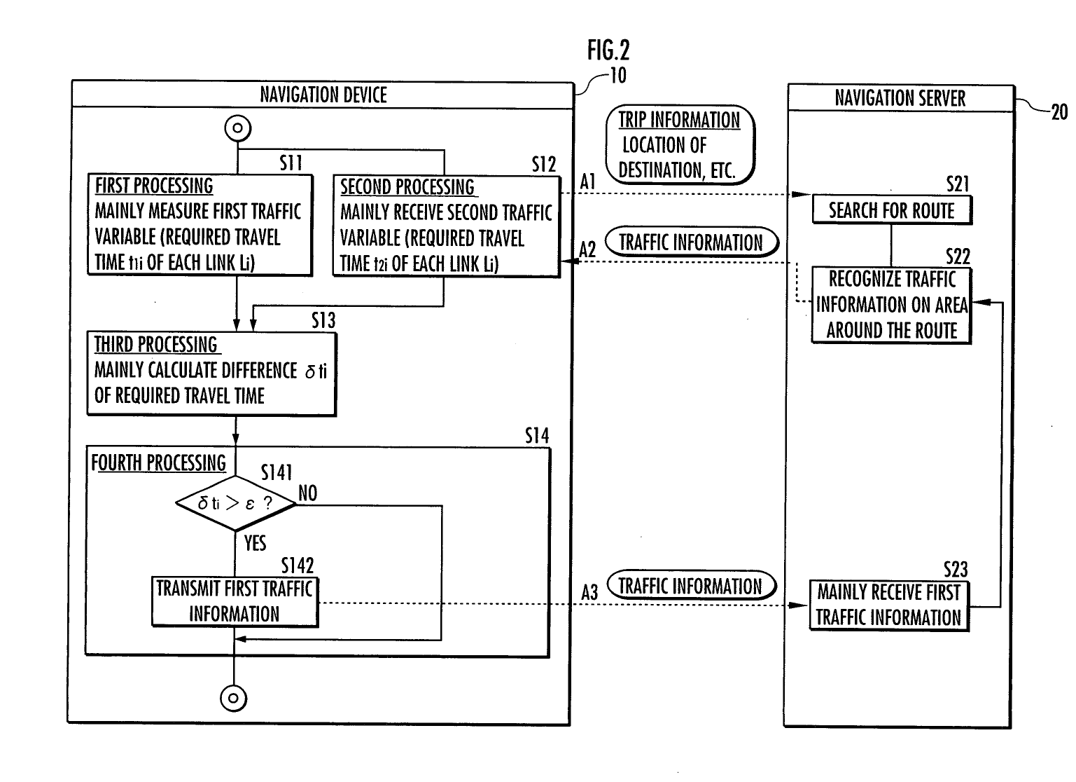

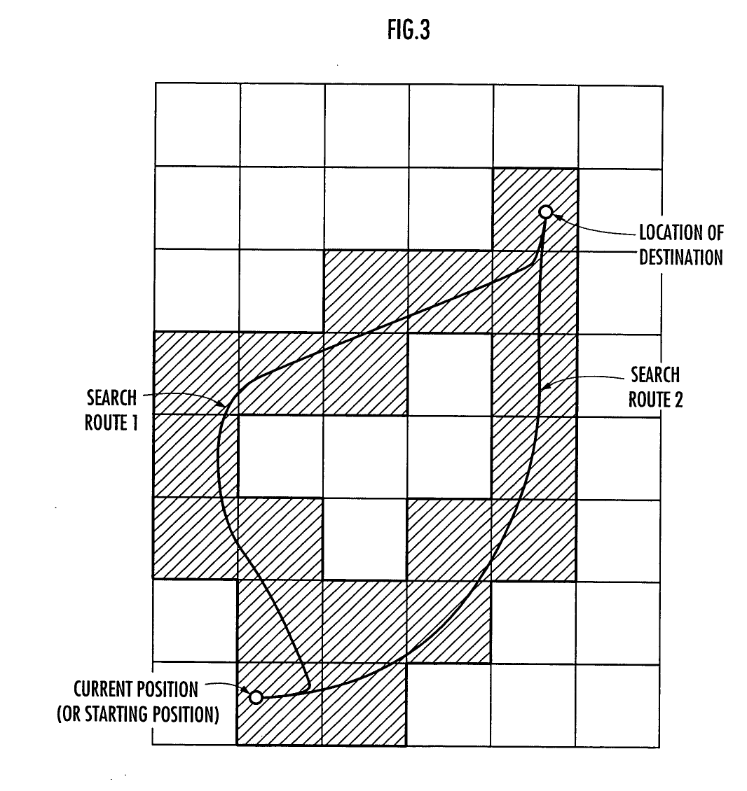

The functions of the traffic information processing device having the construction described above will be explained in conjunction with FIG. 2 and FIG. 3.

The first processor 111 carries out first processing in S11 shown in FIG. 2. Specifically, first, the first processor 111 determines whether a current position of the vehicle 1 measured by a GPS (not shown) matches a node, such as an intersection point or a branch point, included in map information stored in a memory of the navi-device 10. Then, the first processor 111 measures the time from a previous determination to a current determination on agreement between a current position of the vehicle 1 and a node as a required travel time t₁ᵢ of the vehicle 1 in a link Lᵢ (i=1, 2, . . . ) connecting a previous node and a current node, and stores the required travel time t₁ᵢ as a first traffic variable in the first storage 121.

Further, the second processor 112 carries out second processing in S12 of FIG. 2. Specifically, at a predetermined timing, such as a timing when the location of a destination is set through a control button of the navi-device 10, the second processor 112 transmits the current position of the vehicle 1 measured by the GPS or a starting position set by a user and trip information that includes the location of the destination to the navi-server 20, as indicated by arrow A1 in FIG. 2.

In response thereto, in S21 of FIG. 2, the navi-server 20 searches for a route from the current position to the location of the destination on the basis of mainly the map information stored in a storage thereof and traffic information, including the required travel time of the vehicle in the link in the map information, as shown in FIG. 3. This route is searched for or set according to a program prepared to minimize the accumulation of required travel time (quickest to reach the location of the destination) or to minimize the use of toll roads (the cheapest to reach the location of the destination). In S22 of FIG. 2, the navi-server 20 further reads traffic information on a link included in the meshes that contain the search routes (indicated by hatching) among the square meshes dividing up a map, as shown in FIG. 3, and transmits the read traffic information to the navi-device 10 (see arrow A2 in FIG. 2). Then, the second processor 112 extracts the required travel time t₂ᵢ of the vehicle in each link Lᵢ based on the traffic information and stores the extracted required travel time t₂ᵢ in the second storage 122 as a second traffic variable. Traffic information stored in the navi-server 20 includes, for example, the required travel time or the estimated travel time of the vehicle in each link gathered by the navi-server 20 from the VICS 30 or a probe car, such as the vehicle 1, equipped with the navi-device 10.

Further, the third processor 113 carries out third processing in S13 of FIG. 2 at predetermined timing, such as timing when the required travel time t₁ᵢ of the vehicle 1 in a predetermined link Lᵢ is measured and stored or when predetermined time is reached. Specifically, on the same link Lᵢ(road unit), a difference δtᵢ between the required travel time t₁ᵢ as the first traffic variable stored in the first storage 121 and the required travel time t₂ᵢ as the second traffic variable stored in the second storage 122 is calculated, and the calculated difference δtᵢ is stored in the third storage 123.

Subsequently, the fourth processor 114 carries out fourth processing in S14 of FIG. 2. Specifically, first, the fourth processor 114 determines in S141 of FIG. 2 whether a difference δtᵢ stored in the third storage 123 exceeds a threshold value ε. The threshold value ε may be set to be inherent to each link on the basis of the length or type (e.g., express highway, open road, shopping street, and one-way street) of the link included in map information. If the difference δtᵢ exceeds the threshold value ε (if YES in S141 of FIG. 2), then the fourth processor 114 transmits the first traffic variable as traffic information to the navi-server 20 in S142 of FIG. 2, as indicated by arrow A3. Meanwhile, if the difference δtᵢ is the threshold value ε or less (if NO in S141 of FIG. 2), then the fourth processor 114 does not transmit the first traffic variable as the traffic information to the navi-server 20.

According to the navi-device 10 in accordance with the present invention, the first traffic variable is transmitted as traffic information to the navi-server 20 only if the difference between a measured traffic variable (the first traffic variable) and a traffic variable based on traffic information distributed from the navi-server 20 (the second traffic variable) has a predetermined magnitude (refer to S14 of FIG. 2). This prevents new traffic information from being transmitted to the navi-server 20 from the navi-device 10 mounted in the vehicle (probe car) 1 when it is hardly necessary to update the traffic information stored in the navi-server 20, thereby restraining a waste of traffic information communication cost. If, for example, the communication cost of a cellular telephone (not shown) connected to the navi-device 10 is charged on an as-used basis, then the cost to a user, a service provider related to a probe car, or others who bear the communication cost will be reduced. In other words, the navi-device 10 in accordance with the present invention controls the volume of traffic information transmitted to the navi-server 20 so as to save traffic information communication cost.

In the aforesaid embodiment, the transmission of the second traffic information to the navi-server 20 has been controlled on the basis of a result indicating whether a difference between the first and the second traffic variables exceeds a threshold value. However, as another embodiment, the transmission of the second traffic information to the navi-server 20 may be controlled on the basis of a result indicating whether a ratio between the first and the second traffic variables exceeds a threshold value.

In the aforesaid embodiment, one link has been used as the road unit; however, as another embodiment, a plurality of continuous links may be used as the road unit.

In the aforesaid embodiment, the required travel time of a vehicle for each link has been used as the first and the second traffic variables; however, as another embodiment, a traffic volume of a vehicle for each link may be used. A traffic volume q of a vehicle for each link may be defined by “q≡x/t” as the function of a number x of vehicles in an adjacent lane recognized during a passage of a link by means of images on an imaging device, such as a CCD camera (not shown), mounted in the vehicle 1, the time required for his or her own vehicle 1 to pass the link being denoted by t.

What is claimed is:

1. A traffic information processing device mounted in a vehicle to process traffic information on a road through which the vehicle travels, comprising:
a first processor that measures a traffic variable based on a traffic condition of a road through which a vehicle has traveled and stores the traffic variable as a first traffic variable in a first storage means;
a second processor that receives traffic information distributed from an external information processing device and stores a traffic variable based on the traffic information as a second traffic variable in a second storage means;
a third processor that calculates a difference or a ratio between the first traffic variable stored in the first storage means and the second traffic variable stored in the second storage means in the same road unit and stores the difference or the ratio in a third storage means; and
a fourth processor that determines whether the difference or the ratio stored in the third storage means exceeds a threshold value, and transmits the first traffic variable as traffic information to an external information processing terminal if the difference or the ratio exceeds the threshold value.

2. The traffic information processing device according to claim 1, wherein the third processor calculates a difference or a ratio of required travel time of a vehicle as the difference or the ratio between the first and the second traffic variables in the same road unit.

3. The traffic information processing device according to claim 1, wherein the third processor calculates a difference or a ratio of a vehicle traffic volume as a difference or a ratio between the first and the second traffic variables in the same road unit.

4. A traffic information processing program for imparting functions for processing traffic information on a road through which a vehicle travels to a device mounted in the vehicle, the functions comprise:
a first processing function for measuring a traffic variable based on a traffic condition of a road through which a vehicle has traveled and for storing the traffic variable as a first traffic variable in a first storage means;
a second processing function for receiving traffic information distributed from an external information processing device and for storing a traffic variable based on the traffic information as a second traffic variable in a second storage means;
a third processing function for calculating a difference or a ratio between the first traffic variable stored in the first storage means and the second traffic variable stored in the second storage means in the same road unit and for storing the difference or the ratio in a third storage means; and
a fourth processing function for determining whether the difference or the ratio stored in the third storage means exceeds a threshold value and transmitting the first traffic variable as traffic information to an external information processing terminal if the difference or the ratio exceeds the threshold value.

5. A vehicle function control system that distributes or broadcasts a part or all of the traffic information processing program according to claim 4 to a device mounted in a vehicle so as to construct the traffic information processing device according to claim 1.
